(19) United States
(12) Patent Application Publication
(10) Pub. No.: US 2014/0217708 A1
(43) Pub. Date: Aug. 7, 2014

(54) OUTER COVER HAVING REINFORCING FIBERS FOR AN INSTRUMENT PANEL AIRBAG DOOR

(71) Applicant: GM GLOBAL TECHNOLOGY OPERATIONS LLC, Detroit, MI (US)

(72) Inventors: Douglas M. Pickett, Sterling Heights, MI (US); Brian P. Hake, Casco, MI (US)

(73) Assignee: GM GLOBAL TECHNOLOGY OPERATIONS LLC, Detroit, MI (US)

(21) Appl. No.: 13/761,457

(22) Filed: Feb. 7, 2013

(51) Int. Cl. B60R 21/2165

(52) U.S. Cl. CPC B60R 21/2165
USPC 280/728.3; 264/279.1

(57) ABSTRACT

An outer cover for an airbag door of an instrument panel includes a substrate formed from a polymer. A score line is formed into a first surface of the substrate to define an airbag deployment tear seam. A fiber is embedded into and integrally formed with the substrate. The fiber is disposed adjacent to the score line to limit particle separation of the polymer outer cover during deployment of an airbag through the outer cover.

### TECHNICAL FIELD

The invention generally relates to an outer cover for an airbag door of an instrument panel of a vehicle.

### BACKGROUND

Passenger supplemental restraint systems (SRS) include an airbag that deploys out of the instrument panel of the vehicle. The instrument panel defines an opening, through which the airbag expands. The opening in the instrument panel is covered by an airbag door.

The airbag door includes an outer cover, often referred to as a skin, and defines a tear seam. During inflation of the airbag, the airbag expands outward, causing the outer cover to rupture along the tear seam. The rapid rupture of the outer cover may cause some particles of the outer cover to separate therefrom.

### SUMMARY

An outer cover for an airbag door of an instrument panel is provided. The outer cover includes a substrate having a first surface and an opposing second surface. A score line is formed into the first surface of the substrate to define an airbag deployment tear seam. A fiber is embedded into and at least partially encapsulated by the substrate. The fiber is disposed adjacent to the score line.

A method of manufacturing an outer cover for an airbag door of an instrument panel of a vehicle is also provided. The method includes heating a polymer until disposed in a semi-molten state, and forming the polymer in a mold to define a substrate. A fiber is embedded into the substrate while the polymer is in the semi-molten state. The polymer is cooled, after embedding the fiber into the substrate, until the polymer is disposed in a solid state such that the fiber is at least partially encapsulated by the substrate.

An airbag door for an instrument panel of a vehicle is also provided. The airbag door includes a core layer, and an outer cover attached to the core layer. The outer cover includes a substrate formed from a polymer. The substrate includes a first surface and an opposing second surface. A score line is formed into the first surface of the substrate to define an airbag deployment tear seam. The score line partitions the first surface of the substrate into a first portion of the first surface and a second portion of the first surface. The first portion and the second portion of the first surface are disposed across the score line from each other. The airbag deployment tear seam includes a generally U-shaped configuration. A first fiber and a second fiber are embedded into and at least partially encapsulated by the substrate. The first fiber is embedded into the first portion of the first surface adjacent to the score line. The second fiber is embedded into the second portion of the first surface adjacent to the score line.

Accordingly, the fiber that is embedded into and integrally formed with the polymer substrate reinforces the substrate adjacent the tear seam. The reinforcing fiber limits particle separation of the polymer substrate during deployment of the airbag through the outer cover.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic cross sectional view of an airbag door.

FIG. 2 is a schematic perspective view of an outer cover for an airbag door.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims.

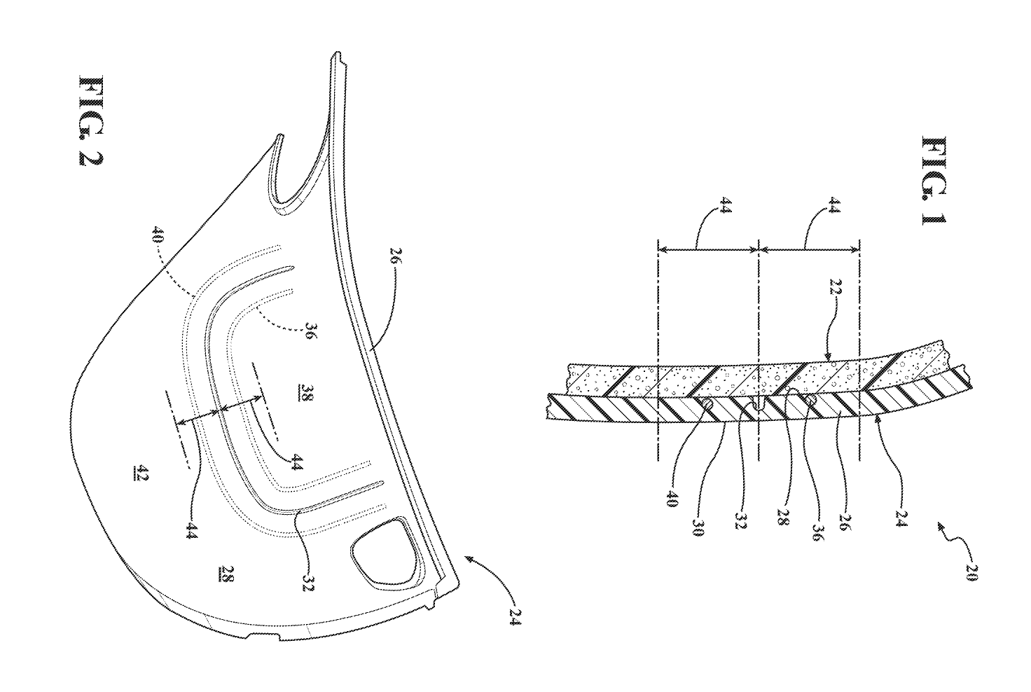

Referring to the Figures, wherein like numerals indicate like parts throughout the several views, an airbag door is generally shown at 20 in FIG. 1. The airbag door 20 is configured for attachment to an instrument panel (not shown) of a vehicle to cover a supplemental restraint system (not shown), i.e., an airbag module.

Referring to FIG. 1, the airbag door 20 includes a core layer 22 that is attached to an outer cover 24, commonly referred to as a skin. The core layer 22 may include any suitable material, such as but not limited to a foam or other similar material capable of supporting the outer cover 24. The outer cover 24 may be attached to the core layer 22 in any suitable manner, such as but not limited to adhering the outer cover 24 to the foam layer, or molding the foam layer onto the outer cover 24.

The outer cover 24 includes a substrate 26 that is formed to define the three dimensional shape of the outer cover 24. The substrate 26 is formed from a polymer. The polymer may include but is not limited to polyvinyl chloride (PVC), thermoplastic olefin (TPO), polyurethane (PU), or some other similar material. The outer cover 24 is formed to define a first surface 28 and an opposing second surface 30. As shown, the first surface 28 may be defined as an interior or inward facing surface that is not visible to an occupant of the vehicle, and the second surface 30 may be defined as an exterior or outward facing surface that is visible to an occupant of the vehicle.

Referring to FIG. 2, a score line 32 is formed into the first surface 28 of the substrate 26. The score line 32 defines an airbag deployment tear seam. The tear seam facilitates a controlled fracture of the outer cover 24 during deployment of the supplemental restraint system. The score line 32 partitions the first surface 28 of the substrate into at least a first portion 38 of the first surface 28, and a second portion 42 of the first surface 28. The first portion 38 of the first surface 28 and the second portion 42 of the first surface 28 are disposed across the score line 32 from each other, i.e., on opposite sides of the score line. As shown, the score line 32 is shaped to define a generally U-shaped configuration disposed on the first surface 28 of the substrate 26. However, it should be appreciated that the score line 32 may be formed to define some other configuration on the first surface 28, such as but not limited to an H-shape, which is suitable for controlling the fracture of the outer cover 24 during deployment of the supplemental restraint system.

At least one fiber 36, 40 is embedded into and integrally formed with the substrate 26. The fiber 36, 40 is disposed adjacent to the score line 32. Preferably, the fiber 36, 40 is disposed on both the first portion 38 and the second portion 42 of the first surface 28, i.e., on opposing sides of the score line 32. For example and as shown, the fiber 36, 40 may include a first fiber 36 disposed on the first portion 38 of the first surface 28, and a second fiber 40 disposed on the second portion 42 of the first surface 28. Accordingly, the second fiber 40 is disposed opposite and across the score line 32 relative to the first fiber 36. While the substrate 26 is shown and described with both the first fiber 36 and the second fiber 40, it should be appreciated that the substrate 26 may include only a single fiber or more than two fibers.

The fibers 36, 40 limit or reduce particle separation of the substrate 26 adjacent the score line 32 during deployment of the supplemental restraint system. In other words, the fibers 36, 40 hold the substrate 26 together in the region immediately adjacent the score line 32 as the substrate 26 is fractured at the score line 32 during deployment of the supplemental restraint system. The fibers 36, 40 may include a single strand of material, or several individual strands of material. The fibers 36, 40 may include and be formed from a woven, non-woven or knitted textile. Preferably, the fibers 36, 40 includes and are manufactured from polyethylene terephthalate (PET), polyamide, cellulose, glass, or other synthetic or natural organic or inorganic fibrous material as necessary to adjust the local material mechanical properties. However, it should be appreciated that the fibers 36, 40 may include some other locally applied filler material capable of limiting particle separation of the substrate 26 during deployment of the supplemental restraint system.

The fibers 36, 40 are spaced an offset distance 44 from the score line 32 to enable the strength of the fibers 36, 40 to reinforce the substrate 26 near the score line 32. Preferably, the offset distance 44 is between the range of 0 mm and 50 mm. However, it should be appreciated that the offset distance 44 may vary with the material used for the substrate 26 and the thickness of the substrate 26, as well as the material used for the fibers 36, 40 and the thickness/diameter of the fibers 36, 40. Accordingly, the offset distance 44 may vary from the exemplary embodiment described herein.

Because the second surface 30 of the substrate 26 is visible to an occupant of the vehicle, neither the fibers 36, 40 nor the score line 32 are visible from the second surface 30 of the substrate 26. As noted above, the fibers 36, 40 are embedded into and at least partially encapsulated by the substrate 26. As such, in order to ensure that the fibers 36, 40 are not visible from the second surface 30 of the substrate 26, the fibers 36, 40 may be embedded into the substrate 26 from the first surface 28 of the substrate 26. As shown in FIG. 1, the fibers 36, 40 may be disposed flush with the first surface 28 of the substrate 26, i.e., only partially encapsulated by the substrate 26, such that a portion of the fibers 36, 40 may be visible from the first surface 28 of the substrate 26. Alternatively, it should be appreciated that the fibers 36, 40 may be completely embedded within the substrate 26, i.e., fully encapsulated by the substrate 26, such that no portion of the fibers 36, 40 is visible from either the first surface 28 or the second surface 30 of the substrate 26.

The substrate 26 may be molded via a rotational molding process. The rotational molding process includes placing the polymer, disposed in a powder state, in a heated mold. The heated mold is then slowly rotated about at least one and preferably two perpendicular axes. The heated mold heats the polymer. As the polymer is heated, the polymer softens into a semi-molten state, thereby allowing the semi-molten polymer to disperse within the mold and flow outward against the walls of the mold to form the substrate 26 and define the shape of the substrate 26.

Once the polymer is heated to the semi-molten state and is formed within the mold to define the shape of the substrate 26, the rotation of the mold is stopped. The fibers 36, 40 may then be embedded into the substrate 26, while the polymer remains in the semi-molten state within the mold. As noted above, the fibers 36, 40 are embedded into the substrate 26 from the first surface 28 of the substrate 26. The fibers 36, 40 may be embedded in any suitable manner. For example, and provided merely as an exemplary process, the fibers 36, 40 may be embedded by opening an access door in the mold at the end of the rotational cycle, through which the fibers 36, 40 may be placed into the semi-molten polymer within the mold. Additional polymer material may also be added at this time to completely encapsulate the fiber 36, 40 if desired.

The fibers 36, 40 are embedded into the substrate 26 adjacent the score line 32, and within the offset distance 44 from the score line 32. As noted above, the offset distance 44 is preferably between the range of 0 mm and 50 mm. As shown in FIG. 2, the fibers 36, 40 re embedded into the substrate 26 such that the fibers 36, 40 are disposed on both the first portion 38 of the first surface 28, and the second portion 42 of the first surface 28, i.e., on opposing sides of the score line 32, with the first fiber 36 embedded into the first portion 38 of the first surface 28, and the second fiber 40 embedded into the second portion 42 of the first surface 28. The fibers 36, 40 may be embedded so that the fibers 36, 40 are completely encapsulated by the polymer, i.e., completely surrounded on all sides by the semi-molten polymer, or may be embedded so that the fibers 36, 40 are only partially encapsulated by the polymer, i.e., are still visible from the first surface 28 of the substrate 26, such as shown in FIG. 1.

Once the fibers 36, 40 are embedded into the substrate 26, the semi-molten polymer is cooled until the polymer is disposed in a solid state, such that the fibers 36, 40 are then at least partially encapsulated by the substrate 26. The polymer may be cooled in any manner suitable for use with the rotational molding process.

The score line 32 is formed in the first surface 28 of the substrate 26 to define the airbag deployment tear seam. The score line 32 may be formed into the first surface 28 of the substrate 26 by any suitable method, such as laser scoring or scoring with a mechanical knife. The score line 32 is formed into the first surface 28 of the substrate 26 after the fibers 36, 40 are embedded into the substrate 26. The outer cover 24 may then be attached to the core of the airbag door 20.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. An outer cover for an airbag door of an instrument panel, the outer cover comprising:
a substrate having a first surface and an opposing second surface;
a score line formed into the first surface of the substrate to define an airbag deployment tear seam, and
at least one fiber embedded into and at least partially encapsulated by the substrate, wherein the at least one fiber is disposed adjacent to the score line.

2. An outer cover as set forth in claim 1 wherein the at least one fiber is spaced an offset distance from the score line, with the offset distance between the range of 0 mm and 50 mm.

3. An outer cover as set forth in claim 1 wherein the score line partitions the first surface of the substrate into a first portion of the first surface and a second portion of the first surface, with the first portion and the second portion disposed across the score line from each other, and wherein the plurality of fibers includes a first fiber embedded into the first portion of the first surface, and a second fiber embedded into the second portion of the first surface and across the score line relative to the first fiber.

4. An outer cover as set forth in claim 1 wherein the substrate includes and is formed from a polymer.

5. An outer cover as set forth in claim 4 wherein the polymer forming the substrate includes one of polyvinyl chloride (PVC), thermoplastic olefin (TPO), or polyurethane (PU).

6. An outer cover as set forth in claim 1 wherein the at least one fiber includes and is formed from polyethylene terephthalate (PET), polyamide, cellulose, or glass.

7. An outer cover as set forth in claim 1 wherein the at least one fiber and the score line are not visible from the second surface of the substrate.

8-18. (canceled)

19. An airbag door for an instrument panel of a vehicle, the airbag door comprising:
a core layer; and
an outer cover attached to the core layer, the outer cover including:
a substrate formed from a polymer, and having a first surface and an opposing second surface;
a score line formed into the first surface of the substrate to define an airbag deployment tear seam having a generally U-shaped configuration;
wherein the score line partitions the first surface of the substrate into a first portion of the first surface and a second portion of the first surface, with the first portion and the second portion disposed across the score line from each other; and
a first fiber and a second fiber embedded into and at least partially encapsulated by the substrate, wherein the first fiber is embedded into the first portion of the first surface adjacent to the score line, and the second fiber is embedded into the second portion of the first surface adjacent to the score line.

20. An airbag door as set forth in claim 19 wherein the each of the first fiber and the second fiber are spaced an offset distance from the score line, with the offset distance between the range of 0 mm and 50 mm.
